(19) United States
(12) Patent Application Publication
(10) Pub. No.: US 2006/0141945 A1
(43) Pub. Date: Jun. 29, 2006

(54) Mobile communication terminal and method therefor

(76) Inventors: Panu Korhonen, Helsinki (FI); Mika Roykkee, Pirkkala (FI); Juha Kaario, Tampere (FI); Ramalingam Hariharan, Tampere (FI); Veera Lattunen, Helsinki (FI); Aki P. Happonen, Kiiminki (FI)

Correspondence Address: PERMAN & GREEN, 425 POST ROAD, FAIRFIELD, CT, 06824, US

(21) Appl. No.: 11/023,323

(22) Filed: Dec. 27, 2004

(51) Int. Cl. H04B 1/38; H04Q 7/20; H04M 11/00

(52) U.S. Cl. 455/90.1

(57) ABSTRACT

A mobile communication apparatus including a user interface UI, a processor, and one or more sensors is disclosed. The one or more sensors are arranged to provide one or more signals, and the processor is arranged to present a warning depending on the one or more signals through the UI. Further, a warning method for a mobile communication apparatus is disclosed. The method includes the steps of: measuring one or more physical quantities; processing the one or more physical quantities to generate one or more warnings; and presenting the one or more warnings through a user interface UI of the mobile communication apparatus.

### BACKGROUND OF THE INVENTION

1. Field of the Invention

The present invention relates to a mobile communication apparatus arranged to present warnings depending on measured physical quantities, and a method for a mobile communication apparatus for measuring the physical quantities and generating and presenting warnings in dependence thereof.

2. Brief Description of Related Developments

A mobile communication apparatus, such as a cell phone, is used in everyday situations. Some of these situations expose the mobile communication apparatus for environments that can be harmful, either for the communication apparatus itself, or its user. Further, in everyday life, it is not always the user is aware of this, since the environment is not always considered by the user. It is therefore a problem that a user may not be aware of environmental exposures.

### SUMMARY OF THE INVENTION

It is therefore an object of the present invention to increase awareness of environmental exposures.

The above object is achieved according to a first aspect of the present invention by a mobile communication apparatus comprising a user interface UI, a processor, and one or more sensors, wherein said one or more sensors are arranged to provide one or more signals, and the processor is arranged to present a warning depending on said one or more signals through the UI.

An advantage of this is increased awareness of environmental exposures sensed by the sensors, presented through the UI, from which the user is used to achieve information.

Said one or more sensors may comprise a humidity sensor, thus said warning comprises an indication that humidity is out of a pre-determined range. The humidity warning may be presented as bubbles on a screen of the UI and sound of water in a speaker of the UI.

An advantage of this is that the user's attention is drawn to the fact that the mobile communication apparatus is exposed to high humidity, and can then take actions to prevent damage, e.g. by placing the mobile communication apparatus in a dry pocket.

Said one or more sensors may comprise an accelerometer, thus said warning comprises an indication that mechanical stress on the mobile communication apparatus is out of a pre-determined range. The warning may then be presented as re-arranged screen contents on a screen of the UI and a sound of a crash in a speaker of the UI.

An advantage of this is that the user's attention is drawn to the fact that the mobile communication apparatus was exposed to shock, and can then take actions to prevent damage, e.g. by handling the mobile communication apparatus more carefully.

Said one or more sensors may comprise a temperature sensor, thus said warning comprises an indication that temperature is out of a pre-determined range. The warning may then be presented as flames on a screen of the UI when a temperature measured by said temperature sensor is above said specified temperature range, or may be presented as icicles on the screen when a temperature measured by said temperature sensor is below said specified temperature range, or any other suitable indication.

An advantage of this is that the user's attention is drawn to the fact that the mobile communication apparatus is exposed to high or low temperatures, and can then take actions to prevent damage, e.g. by removing the mobile communication apparatus from a hot dashboard of a car if high temperature is indicated, or placing the mobile communication apparatus in a warm pocket if low temperature is indicated.

Said one or more sensors may comprise a radiac sensor, and said warning comprises an indication that radioactivity is out of a pre-determined range. The radioactivity warning may be presented as sound of a Geiger-Müller counter in a speaker of the UI.

An advantage of this is that the user's attention is drawn to the fact that radioactivity is present, and can then take actions to prevent exposure to radioactivity, e.g. by moving out of the area.

The mobile communication apparatus may further comprise a memory, wherein the memory is arranged to store said warning.

An advantage of this is improved knowledge of errors if the mobile communication apparatus is handed in to be serviced.

The UI may comprise a screen, an audio output, which may comprise a speaker and/or a buzzer, or a vibrator, or any combination of these, arranged to present said warning.

The above object is achieved according to a second aspect of the present invention by a warning method for a mobile communication apparatus, comprising the steps of: measuring one or more physical quantities; processing said one or more physical quantities to generate one or more warnings; and presenting said one or more warnings through a user interface UI of the mobile communication apparatus.

The warning method may further comprise the step of storing the warning in a memory.

The warning method may further comprise the step of receiving an acknowledgement on the warning from a user.

The processing step may further comprise the steps of: determining if said one or more physical quantities are out of corresponding pre-determined ranges; and generating one or more warnings corresponding to those of said one or more physical quantities determined to be out of corresponding ranges.

The one or more warnings may be presented on a screen, in a speaker, by a buzzer or by a vibrator of said UI, or any combination thereof.

The one or more physical quantities may comprise humidity, acceleration, temperature, or radiactivity, or any combination thereof.

The advantages of the second aspect of the present invention are similar to those of the first aspect.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:—

FIG. 1 is a block diagram schematically showing a mobile communication apparatus according to an embodiment of the present invention;

FIG. 2 shows a mobile communication apparatus according an embodiment of to the present invention;

FIG. 3 illustrates an example of a screen view displayed on a display of a mobile communication apparatus;

FIG. 4 illustrates an example of a screen view displayed on a display of a mobile communication apparatus when a warning is presented due to registered mechanical effects;

FIG. 5 illustrates an example of a screen view displayed on a display of a mobile communication apparatus when a warning is presented due to registered high humidity;

FIG. 6 illustrates an example of a screen view displayed on a display of a mobile communication apparatus when a warning is presented due to registered high radioactivity;

FIG. 7 illustrates an example of a screen view displayed on a display of a mobile communication apparatus when a warning is presented due to registered low temperature;

FIG. 8 illustrates an example of a screen view displayed on a display of a mobile communication apparatus when a warning is presented due to registered high temperature; and

FIG. 9 is a flow chart illustrating a warning method.

### DETAILED DESCRIPTION OF PREFERRED EMBODIMENTS

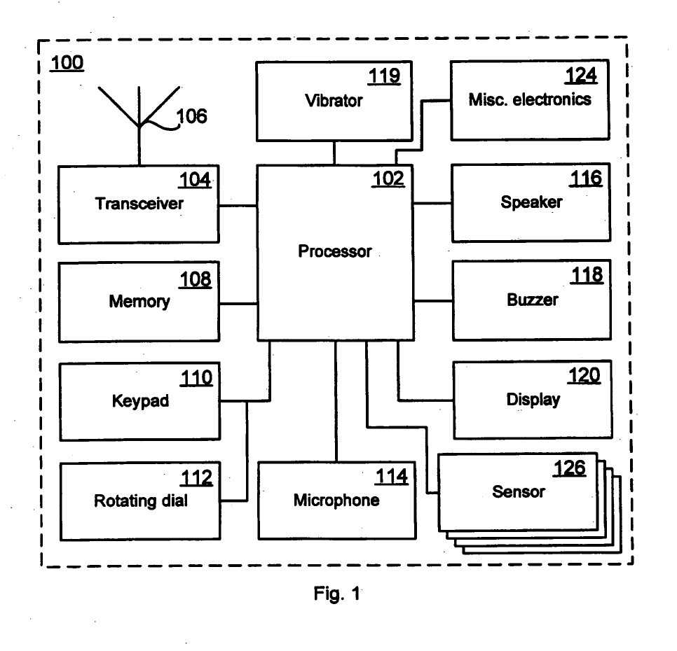

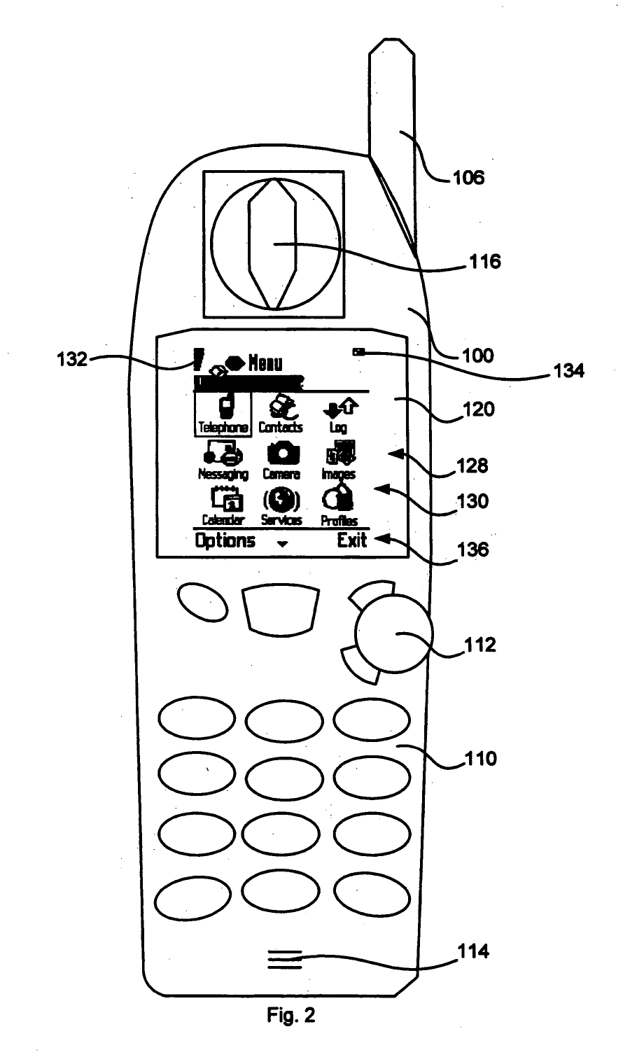

FIG. 1 is a block diagram schematically showing a mobile communication apparatus 100 according to an embodiment of the present invention, and FIG. 2 shows a mobile communication apparatus 100. The mobile communication apparatus 100 comprises a processor 102 which is arranged to control functions of the mobile communication apparatus 100. In FIG. 1, the connections between elements 104, 108, 110, 112, 114, 116, 118, 119, 120, 124, 126 and the processor 102 depicts the control of the elements 104, 108, 110, 112, 114, 116, 118, 119, 120, 124, 126, as well as signal transfer and information exchange. However, the elements 104, 108, 110, 112, 114, 116, 118, 119, 120, 124, 126 can have any interconnection for signals or information transfer to any of the other elements 104, 108, 110, 112, 114, 116, 118, 119, 120, 124, 126, which interconnections are not shown in FIG. 1 for clarity reasons. The mobile communication apparatus 100 further comprises a transceiver 104 connected to the processor 102 which is arranged to receive and transmit radio signals through an antenna 106. The mobile communication apparatus can further comprise a memory 108, a keypad 110, a rotating dial 112, a microphone 114, a speaker 116, a buzzer 118, a vibrator 119, and a display 120. Further miscellaneous electronics 124, such as means for infrared data association (not shown), can also be comprised. In the display 120 of FIG. 2, an example of a screen view is shown, comprising a plurality of items 128, such as icons 130 for different features of the mobile communication apparatus 100, a signal strength indicator 132, an indicator 134 for received messages, and alternatives 136 for navigation between menus.

The mobile communication apparatus comprises one or more sensors 126 arranged to provide signals depending on measured quantities, such as mechanical effects, humidity, temperature, radioactivity, atmospheric pressure, air pollution, oxygen content, etc. The processor 102 receives the signals and determines if any of the quantities are out of a pre-determined range. If one or more of the quantities are out of the predetermined range, the processor generates one or more warnings, accordingly, and present the one or more warnings through a user interface of the mobile communication apparatus 100. The outputs of the user interface normally comprise the speaker 116, buzzer 118, vibrator 119 and display 120.

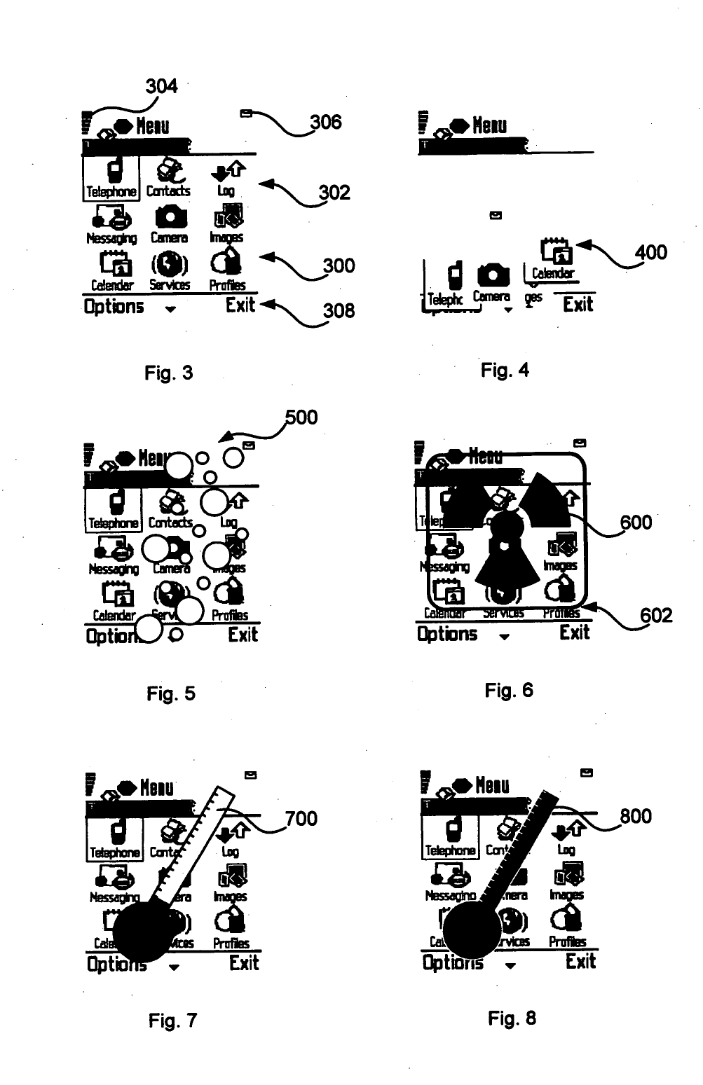

FIG. 3 illustrates an example of a screen view displayed on a display of a mobile communication apparatus, comprising a plurality of items 300, such as icons 302 for different features of the mobile communication apparatus, a signal strength indicator 304, an indicator 306 for received messages, and menu navigation alternatives 308.

FIG. 4 illustrates an example of a screen view displayed on a display of a mobile communication apparatus when a warning is presented due to registered mechanical effects, e.g. the mobile communication apparatus has been exposed to a shock, which has been registered by an accelerometer. The accelerometer provides a signal indicating the acceleration the mobile communication apparatus has beed exposed to, and the processor, which reveives the signal, determines if the acceleration is out of a pre-defined range. For example, the pre-defined range is chosen as a range in which the mechanical stress of the mobile communication apparatus is acceptable. If the acceleration is out of the pre-defined range, a warning is generated, and can be presented as depicted in FIG. 4, where items 400 of the screen view are re-arranged as if they got loose at the shock. Further, a warning text (not shown) can be provided, and/or a sound can be played, e.g. a sound of a crash. The warning can be stored in a memory, e.g. to facilitate service of the mobile communication apparatus. When the warning is acknowledged by the user the screen is returned ot its original appearance before the warning was displayed. For the case in FIG. 4 this would mean that the items 400 are put back in their original places as they were before the shock arose.

FIG. 5 illustrates an example of a screen view displayed on a display of a mobile communication apparatus when a warning is presented due to registered high humidity, e.g. the mobile communication apparatus has been exposed to water, which has been registered by a humidity sensor. The humidity sensor provides a signal indicating the humidity the mobile communication apparatus has beed exposed to, and the processor, which reveives the signal, determines if the humidity is out of a pre-defined range. For example, the pre-defined range is chosen as a range in which the humidity inside the mobile communication apparatus is acceptable. If the humidity is out of the pre-defined range, a warning is generated, and can be presented as depicted in FIG. 5, with bubbles 500, which can be animated to move over the screen, to indicate a too high humidity inside the mobile communication apparatus. Further, a warning text (not shown) can be provided, and/or a sound can be played, e.g. a sound of a splash. The warning can be stored in a memory, e.g. to facilitate service of the mobile communication apparatus.

FIG. 6 illustrates an example of a screen view displayed on a display of a mobile communication apparatus when a warning is presented due to registered high radioactivity, e.g. the mobile communication apparatus has been exposed to radioactive fallout, which has been registered by a radiac sensor. The radiac sensor provides a signal indicating the radioactivity the mobile communication apparatus has beed exposed to, and the processor, which reveives the signal, determines if the radioactivity is out of a pre-defined range. For example, the pre-defined range is chosen as a range in which the radioactivity the mobile communication apparatus is exposed to is acceptable for a user. If the radioactivity is out of the pre-defined range, a warning is generated, and can be presented as depicted in FIG. 6, with a symbol 600 of radioactivity over the ordinary items 602 to indicate a too high radioactivity around the mobile communication apparatus. Further, a warning text (not shown) can be provided, and/or a sound can be played, e.g. a sound of a Geiger counter. The warning can be stored in a memory, e.g. to track radiac exposure of the user.

FIGS. 7 and 8 illustrate examples of screen views displayed on a display of a mobile communication apparatus when warnings are presented due to registered low or high temperature, respectively. The temperature sensor provides a signal indicating the temperature of the mobile communication apparatus, and the processor, which reveives the signal, determines if the temperature is out of a pre-defined range. For example, the pre-defined range is chosen as a range in which the temperature inside the mobile communication apparatus is acceptable. If the temperature is out of the pre-defined range, a warning is generated, and can be presented as depicted in FIG. 7 if the temperature is below the pre-defined range, with a symbol 700 to indicate a too low temperature inside the mobile communication apparatus. The warning can be presented as depicted in FIG. 8 if the temperature is above the pre-defined range, with a symbol 800 to indicate a too high temperature inside the mobile communication apparatus. Further, a warning text (not shown) can be provided, changed background color (not shown) of the display, and/or a sound can be played. Here, when indicating the warning by changing colors, SPR c4 should be taken into consideration. A user can then take appropriate measures to get the temperature into the range, e.g. putting the mobile communication apparatus in a warm pocket if the temperature is too low, or remove it from the hot dashboard of the car if the temperature is too high. The warning can be stored in a memory, e.g. to facilitate service of the mobile communication apparatus.

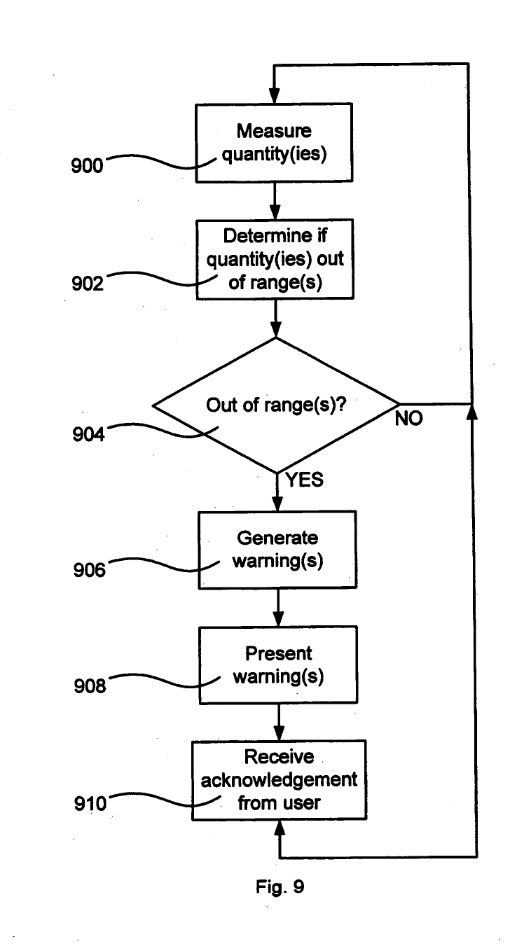

FIG. 9 is a flow chart illustrating a warning method for a mobile communication apparatus. In a quantity measuring step 900, one or more physical quantities are measured. The one or more measured physical quantities are processed to determine if any of them are out of pre-defined ranges for the physical quantities, respectively, in a determination step 902. The method returns to the measuring step 900 from a check step 904 if no quantities are determined to be out of ranges in the determination step 902. Otherwise the method goes from the check step 904 to a warning generation step 906, where one or more warnings are generated according to quantities determined to be out of ranges. The generation step 906 can also comprise storing the warning in a memory. In a warning presentation step 908, the one or more warnings generated in the warning generation step 906 are presented. The presentation of the one or more warnings are performed through a user interface of the mobile communication apparatus. The outputs of the user interface normally comprise a speaker, buzzer, vibrator and/or display. Thus the warnings can be received by a users eyes, ears, and/or perception of touch. In an acknowledgement reception step 910 an acknowledgement from a user can be received to cancel the warning, and the method then returns to the measuring step 900.

1. A mobile communication apparatus comprising:
a user interface UI;
a processor; and
one or more sensors, the one or more sensors being able to sense at least one operational condition within the mobile communication apparatus;
wherein the one or more sensors are arranged to provide one or more signals corresponding to the at least one sensed operational condition, and the processor is arranged to determine if the at least one sensed operational condition is outside a corresponding pre-determined operational range of the mobile communication apparatus and to present a warning depending on the one or more signals through the UI.

2. The mobile communication apparatus according to claim 1, wherein the one or more sensors comprise a humidity sensor, and the warning comprises an indication that humidity is out of a pre-determined operational range of the mobile communications apparatus.

3. The mobile communication apparatus according to claim 1, wherein the one or more sensors comprise an accelerometer, and the warning comprises an indication that mechanical stress on the mobile communication apparatus is out of a pre-determined operational range of the mobile communications apparatus.

4. The mobile communication apparatus according to claim 1, wherein the one or more sensors comprise a temperature sensor, and the warning comprises an indication that temperature is out of a pre-determined operational range of the mobile communications apparatus.

5. The mobile communication apparatus according to claim 1, wherein said one or more sensors comprise a radiac sensor, and said warning comprises an indication that radioactivity is out of a pre-determined operational range of the mobile communications apparatus.

6. The mobile communication apparatus according to claim 1, further comprising a memory, said memory being arranged to store said warning.

7. The mobile communication apparatus according to claim 1, wherein said UI comprises a screen, said screen being arranged to present said warning.

8. The mobile communication apparatus according to claim 1, wherein said UI comprises an audio output, said audio output being arranged to present said warning.

9. The mobile communication apparatus according to claim 8, wherein said audio output comprises a speaker or a buzzer, or a combination thereof.

10. The mobile communication apparatus according to claim 1, wherein said UI comprises a vibrator, said vibrator being arranged to present said warning.

11. A warning method for a mobile communication apparatus, comprising the steps of:
measuring one or more operational conditions within the mobile communication apparatus;
processing the one or more operational conditions to generate one or more warnings when the one or more operational conditions are outside a corresponding pre-determined operating range of the mobile communication apparatus; and
presenting the one or more warnings through a user interface UI of the mobile communication apparatus.

12. The warning method according to claim 11, further comprising the step of storing said warning in a memory.

13. The warning method according to claim 11, further comprising the step of receiving an acknowledgement on said warning from a user.

14. (canceled)

15. The warning method according to claim 11, wherein said one or more warnings are presented on a screen, in a speaker, by a buzzer or by a vibrator of said UI, or any combination thereof.

16. The warning method according to claim 11, wherein the one or more operational conditions within the mobile communication apparatus humidity, acceleration, temperature, or radioactivity, or any combination thereof.

17. The warning method according to claim 11, wherein a thermometer is displayed on a screen of the mobile communication apparatus when a temperature of the mobile communication device is outside a pre-determined operational range.

18. The warning method according to claim 11, wherein at least one item on a screen of the mobile communication apparatus is graphically rearranged wherein the at least one item appears loosened from an original screen position when a mechanical stress of the mobile communication apparatus is outside a pre-determined operational range.

19. The warning method according to claim 11, wherein animated bubbles are displayed on a screen of the mobile communication apparatus when a humidity of the mobile communication apparatus is outside a pre-determined operational range.

20. The warning method according to claim 11, wherein a trefoil symbol is displayed on a screen of the mobile communication apparatus when a radioactivity of the mobile communication apparatus is outside a pre-determined operational range.
